(19) United States
(12) Patent Application Publication
(10) Pub. No.: US 2020/0235930 A1
(43) Pub. Date: Jul. 23, 2020

(54) TRANSPORTATION VEHICLE TRANSACTIONAL SECURITY AUTHENTICATION

(71) Applicants: VOLKSWAGEN AG, Wolfsburg (DE); PORSCHE AG, Stuttgart (DE); AUDI AG, Ingolstadt (DE)

(72) Inventors: Benedict A. RECKTENWALD, Sunnyvale, CA (US); Ian KENDALL, San Mateo, CA (US)

(21) Appl. No.: 16/254,681

(22) Filed: Jan. 23, 2019

(51) Int. Cl. H04L 9/32; H04B 11/00; H04W 4/44; G06Q 20/38; G01S 15/08; G01S 15/93

(52) U.S. Cl. CPC H04L 9/3213; H04B 11/00; H04W 4/44; G01S 2015/932; H04L 9/3247; G01S 15/08; G01S 15/931; G06Q 20/3821

(57) ABSTRACT

Devices, systems, and methodologies for transportation vehicle communications using ultrasonic devices to communicate embedded communication signals with other infrastructure. A communication system may communicate with the ultrasonic devices to provide communication signals.

### FIELD

Disclosed embodiments relate to devices, systems, and methodologies of transportation vehicles. In particular, presently disclosed embodiments relate to devices, systems, and methodologies for transportation vehicle communications.

### SUMMARY

In accordance with illustrative embodiments, a transportation vehicle may include a communication system and sound generator for providing communication with infrastructure via sound signals.

In accordance with illustrative embodiments, a transportation vehicle for secure communications may comprise a vehicle chassis, a communication system including a processor and a memory device, the processor executing instructions stored on the memory device to provide communication commands based on the executed instructions, and a sound generation means for providing one or more sound signals based on the communication commands from the communication system. The one or more sound signals may include a token having a signature to enable verification that the token remains unaltered.

In illustrative embodiments, the token may include a payload for communication to one or more infrastructure devices. The payload may include payment information. The token is encrypted to conceal the payload from unauthorized access.

In illustrative embodiments, the sound generation means may include an ultrasonic sound generator. The sound signals may include ultrasonic frequencies. The ultrasonic generator is an ultrasonic parking device for determining distance between the transportation vehicle and an obstacle.

In illustrative embodiments, the sound generation means may include a sound receiver for receiving sound signals. The sound receiver may receive inbound sound signals from one or more infrastructure devices and communicates the inbound sound signals to the communication system. The sound receiver may include an ultrasonic parking sensor for detecting distance of the transportation vehicle from an obstacle.

### BRIEF DESCRIPTION OF THE FIGURES

The detailed description particularly refers to the accompanying figures in which:

FIG. 1 is a perspective view of a transportation vehicle including a communications system and transmitters for communicating sound signals with other infrastructure;

FIG. 2 includes elevation and plan views of the transportation vehicle of FIG. 1 showing that the transmitters can be ultrasonic parking sensors providing ultrasonic signals;

FIG. 3 is a diagrammatic view of the communication system in communication with infrastructure via the transmitters;

FIG. 4 is a diagrammatic view of operations of the communication system showing that communication system performs communication and/or auxiliary operations and security operations, and generates a command for the transmitter; and

FIG. 5 is a flow diagram indicating a security operation of the communication system.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the presently disclosed embodiments, a discussion of such elements and operations may not be provided herein. However, the presently disclosed embodiments are deemed to inherently include all such elements, variations, and modifications to the described aspects that would be known to those of ordinary skill in the art.

Advances in the incorporated technology of transportation vehicles can improve the transportation experience and/or safety. As transportation vehicle technology advances, for example, in the realm of autonomous and/or semi-autonomous transportation vehicles, communications between the transportation vehicle itself and other infrastructure can improve the transportation experience and/or safety. For example, communication between the transportation vehicle and infrastructure such as roadway elements (e.g., traffic lights, signs, traffic control information servers, etc.), other vehicles, and/or other fixed infrastructure elements (e.g., gates, garage doors, etc.) can enhance the transportation experience and/or safety. Moreover, the number, arrangement and/or type of devices and/or systems can face challenges as transportation vehicle technology advances. Configuring systems for enhanced operational use can increase the value and/or effectiveness of the incorporated technology.

Referring to FIG. 1, a transportation vehicle 10 is shown which may include a communication system 12 for conducting communication between the transportation vehicle 10 and other infrastructure. The communication system 12 may perform communications operations to communicate signals between the transportation vehicle 10 and other infrastructure. The transportation vehicle 10 may include transmitters 14 for communicating signals as directed by the communication system 12. The transmitters 14 may be arranged on the front, rear, top, bottom, and/or sides of the vehicle chassis. In illustrative embodiments, the transmitters 14 may form sound generation means for providing communication signals as sound signals.

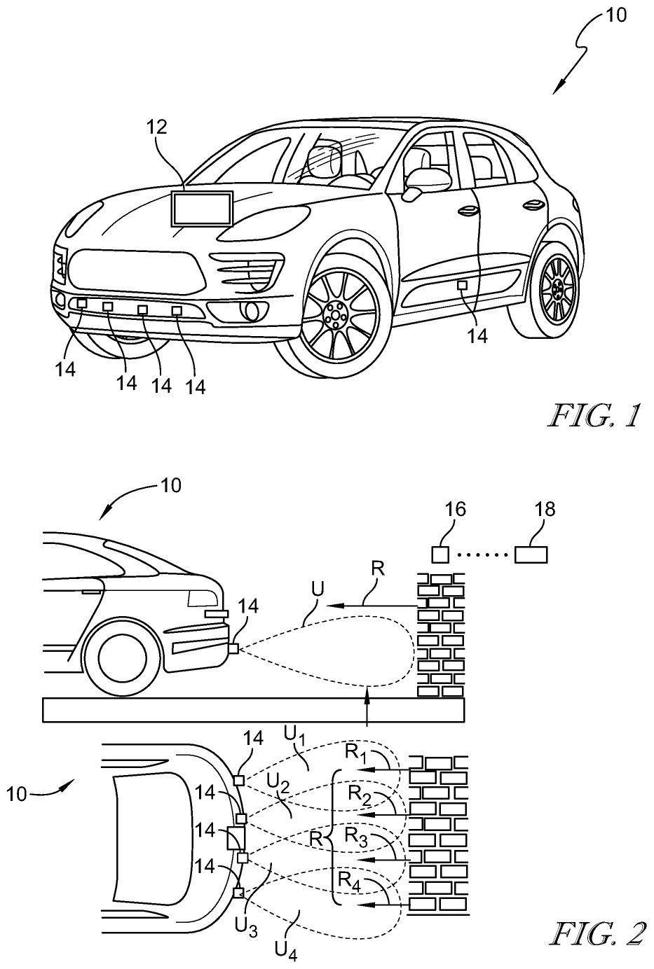

Referring to FIG. 2, the transmitters 14 may be ultrasonic transmitters, such as ultrasonic parking sensors. The ultrasonic parking sensors 14 can generate sound signals in the ultrasonic range, for example, within the range of about 20 kHz to about 200 MHz, although frequencies above 200 MHz may be applied as ultrasonic. By communicating signals in the ultrasonic range, the signals are typically inaudible to humans while providing reliable and relatively secure short-range transmission.

As suggested in FIG. 2, the ultrasonic parking sensors 14 may each produce sound signals Uᵢ, embodied as ultrasonic parking signals. The ultrasonic sound signals Uᵢ may be localized directional signals which can reflect from infrastructure, such as a brick impediment, and can produce reflection signals Rᵢ. As suggested in FIG. 2, each ultrasonic parking sensors 14 may each produce ultrasonic sound signals U₁₋₄ which may each generate a corresponding reflection signal R₁₋₄, although depending on the particular parking scenario, not all signals Uᵢ may result in a reflection signal Rᵢ. The reflection signals R₁₋₄ may collectively form a combined reflection signal R. In addition to transmitting the ultrasonic signals Uᵢ, the ultrasonic parking sensors 14 may also be formed as receivers (or transceivers) to receive the reflection signals Rᵢ to determine the distance and/or direction between the transportation vehicle 10 and the obstacle, such as the brick impediment, according to the time difference and/or other comparative characteristics between the signals Uᵢ& Rᵢ. In some embodiments, receivers may be formed as devices distinct from the transmitters.

Referring still to FIG. 2, the ultrasonic parking sensors 14 may be controlled to communicate an embedded communications signal within their ultrasonic parking signals Uᵢ. The infrastructure may include a communications device 16 for receiving and processing the embedded communications signal. The communications device 16 may be embodied as a wireless communications device of any manner of infrastructure communication system, such as a gate authorization device, parking validation device, and/or payment terminal. For example, the communications device 16 may be embodied as a payment terminal for parking and/or other activity which receives payment information indicated within the embedded communications signal. The communications device 16 may itself process communications, such as payment transactions, from the transportation vehicle and/or may be arranged in communication with a remote server 18 for processing, such as to verify payment transactions.

The use of ultrasonic parking sensors for communications between the transportation vehicle and other infrastructure can provide localized security. For example, the directional nature of the ultrasonic signal can limit the range of relative directions that the embedded communication signal is broadcast. Moreover, ultrasonic parking sensors are typically formed for wireless, but relatively local transmission, for example, within the range of about zero feet to about 50 feet. Still further, communication using the ultrasonic parking sensors reduces the need for additional hardware dedicated to communications, reducing the spatial needs and related design requirements of the incorporated technology.

The embedded communication signals may include additional security features. For example, the embedded communication signals may include token-based authentication. The embedded communication signals may include a token having a header, payload, and signature. The signature can enable verification that the token remains unaltered from its state at origination. The token may be encrypted to conceal information against unauthorized access.

Continuing from the earlier example of payment transactions, an indication of payer's payment information may be encrypted and sent as part of the payload of the token from the transportation vehicle 10 to the communications device 16. The communications device 16 may verify the payment information by accessing the encrypted token via decryption tools. For example, the communications device 16 may include decryption tools and/or access decryption tools via the remote server 18. Accordingly, a secure payment transaction can occur between the transportation vehicle 10 and the infrastructure. In practice, the secure payment transaction can be embodied as payment for parking, entry to secure spaces such as toll roadways, fuel/charging, and/or any other payment transaction. Secure communications is not limited to payment communications but may include any suitable communication type, for example, secure communication for identification to access to secure physical sites through a security barrier such as a gate, and/or secure communication of navigational intent between the transportation vehicle 10 and other vehicles on roadways.

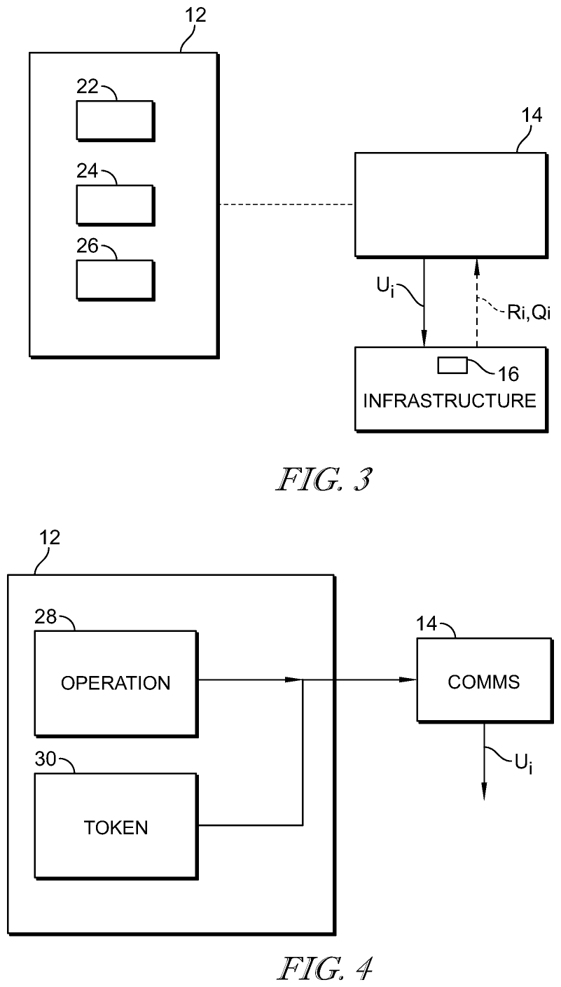

Referring to FIG. 3, the communication system 12 may perform communications operations. The communication system 12 may include a processor 22 for executing instructions stored on a memory device 24, and communications circuitry 26 for providing command signals to the transmitters 14 according to direction by the processor 22 based on the execution of the instructions. The communication system 12 may store the relevant token and/or encryption information, for example token and/or encryption algorithms, already known to the communications device 16 and/or remote server 18.

The communication system 12 provides signals to the transmitters 14 for transmission to the infrastructure. In additional to communications, the communication system 12 may provide processing operations to enable ultrasonic parking, although in some embodiments ultrasonic parking operations may be conducted by alternative processor devices through the ultrasonic parking sensors 14. In illustrative embodiments, the communications device 16 may provide communication signals Qᵢ to the transportation vehicle 10, which may be captured by the receivers (or transceivers) and processed by the communication system 12. The communication signals Qi may include confirmation and/or response information as an embedded sound signal, similar to the communication signals Uᵢ. For example, the communication signals Qᵢ may include a payment confirmation for receipt by the transportation vehicle. The communication signals Qi may include token and/or encryption security similar to the communication signals Uᵢ.

Referring to FIG. 4, a diagrammatic illustration of the operations of the communication system 12 indicates that the communication system 12 may provide diverse functionality. The communication system 12 may provide communications operations 28 which may include communication functions and/or other functions such as parking sensors operations. The communication system 12 may provide security operations 30 which may include token authentication and/or encryption operations. The communication system 12 may provide commands to the transmitters 14 to provide the communication signals Uᵢ for the auxiliary functions with the embedded communication signals for the communication functions including the token authenticated and/or encrypted information.

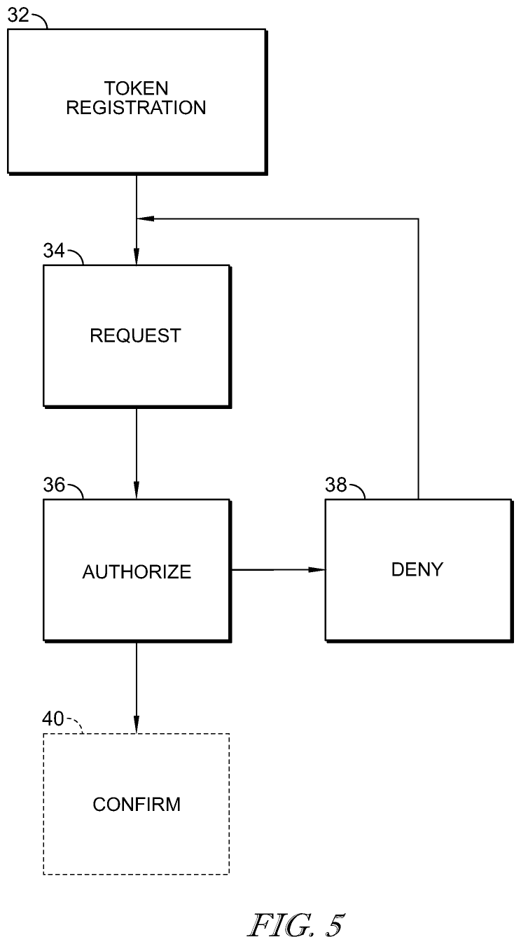

Referring to FIG. 5, a flow diagram of token verification is shown in which secure communications may be conducted. In box 32, token and/or encryption registration may be performed. The transportation vehicle 10 may perform the token and/or encryption registration. The registration may include registering an account and obtaining token and/or encryption information, such as token signature and/or encryption algorithms. The registration may be performed by independent communication with a central server, which may include and/or have communication with remote server 18 and/or communications device 16.

In box 34, a request may be made. Continuing from the earlier example of payment transactions, the request may be a request from the transportation vehicle 10 to the communications device 16 to execute payment. In some embodiments, the request may include an initial prompt and/or response, for example, the communications device 16 may initially prompt the transportation vehicle 10 for payment information. The request may include token authentication and/or encryption features.

In box 36, an authorization may be performed. The authorization may include determination that the request is valid such as by token authentication. Continuing from the earlier example of payment transactions, the authorization may include decryption as required, authentication of the token signature, and/or payment authentication and processing. In illustrative embodiments, the authorization may be performed by the communications device 16 responsive to the request for payment by the transportation vehicle, but in some embodiments, the transportation vehicle 10 may conduct authorization.

In response to a failed authorization in box 36, a denial may be performed in box 38. The denial may include denial of response, access, and/or other operations (e.g., payment) in response to the request of box 34. Continuing from the earlier example of payment transactions, the denial may include denial of payment. The denial may include a response indicating the denial, for example, in embodiments in which the communications device 16 performs the authorization, the communications device 16 may send an indication of denial to the transportation vehicle 10 upon failed authorization. An indication of denial may be presented to the user, for example, via a display screen of the transportation vehicle 10.

In response to successful authorization in box 36, optionally, a confirmation may be provided in box 40. The confirmation may include confirmation of response, access, and/or other operations (e.g., payment) in response to the successful authentication of box 34. The confirmation may include sending an indication of successful authorization. Continuing from the earlier example of payment transactions, the confirmation may include confirmation of successful payment. The confirmation may include sending a response indicating the successful payment, for example, in embodiments in which the communications device 16 performs the authorization, the communications device 16 may send an indication of successful payment to the transportation vehicle 10 upon successful authorization. An indication of confirmation may be presented to the user, for example, via a display screen of the transportation vehicle 10.

The presently disclosed embodiments may be implemented in conjunction with parking systems, wherein vehicles may have ultrasonic senders and receivers to determine distance to objects and obstacles behind the vehicles, in front and rear of the vehicle. This existing functionality the system can be used to communicate between vehicles and infrastructure. The existing sensors on the vehicle can be used and adapted to include information to be communicated between vehicles as a modulated signal on top of the ultrasonic carrier. The system may then send information and measure distance to obstacles and objects. This could further be adapted to only send data when the system is in range with an object that accepts a signal and returns a response/request for data.

In accordance with disclosed embodiments, the use of ultrasonics can enable more secure directional message transfer between a specific sensor and the receiver. The presently disclosed embodiments provide technical solutions for transportation vehicle communication with infrastructure using senders and sensors to provide enhanced security by using a manner of communication not normally associated with data transfer while significantly reducing cost and/or complexity by using existing hardware. Transportation vehicles provided in accordance with the presently disclosed embodiments may be configured to communicate secure signals with infrastructure to verify information for identification, payment, etc. The use of ultrasonics can enable enhanced security in directional message transfer between a specific sensor and the receiver.

In the presently disclosed embodiments, a communication system for providing secure communications between a transportation vehicle and infrastructure may comprise a communication control system including a processor and a memory device, the processor executing instructions stored on the memory device to provide commands based on the executed instructions, and a sound generator for providing one or more sound signals based on the commands from the communication system. The one or more sound signals may include a token having a signature to enable verification that the token remains unaltered.

In the presently disclosed embodiments, the token may include a payload for communication to one or more infrastructure devices. The payload may include payment information. The token may be encrypted to conceal the payload from unauthorized access.

In illustrative embodiments, the sound generator may include an ultrasonic sound generator. The sound signals may include ultrasonic frequencies. The ultrasonic generator may include an ultrasonic parking device for determining distance between the transportation vehicle and an obstacle.

In illustrative embodiments, the sound generator may include a sound receiver for receiving sound signals. The sound receiver may receive inbound sound signals from one or more infrastructure devices. The sound receiver may communicate the inbound sound signals to the communication system. The sound receiver may include an ultrasonic parking sensor for determining distance between the transportation vehicle and an obstacle. Additional authentication and encryption security features can afford further protection against unintended access to information. Moreover, the potential for interference may be combatted with authentication and encryption security features, including but without limitation, interference at significant speeds of travel.

Although certain embodiments have been described and illustrated in exemplary forms with a certain degree of particularity, it is noted that the description and illustrations have been made by way of example only. Numerous changes in the details of construction, combination, and arrangement of parts and operations may be made. Accordingly, such changes are intended to be included within the scope of the disclosure, the protected scope of which is defined by the claims.

We claim:

1. A transportation vehicle including equipment for providing secure communication, the transportation vehicle comprising:
a vehicle chassis;
a communication system including a processor and a memory device, the processor executing instructions stored on the memory device to provide communication commands based on the executed instructions; and
a sound generation means for providing one or more sound signals based on the communication commands from the communication system, wherein the one or more sound signals include a token having a signature enabling verification that the token remains unaltered.

2. The transportation vehicle of claim 1, wherein the token includes a payload for communication to one or more infrastructure devices.

3. The transportation vehicle of claim 2, wherein the payload includes payment information.

4. The transportation vehicle of claim 2, wherein the token is encrypted to conceal the payload from unauthorized access.

5. The transportation vehicle of claim 1, wherein the sound generation means includes an ultrasonic sound generator and the sound signals include ultrasonic frequencies.

6. The transportation vehicle of claim 5, wherein the ultrasonic generator is an ultrasonic parking device for determining distance between the transportation vehicle and an obstacle.

7. The transportation vehicle of claim 1, wherein the sound generation means includes a sound receiver for receiving sound signals.

8. The transportation vehicle of claim 7, wherein the sound receiver receives inbound sound signals from one or more infrastructure devices and communicates the inbound sound signals to the communication system.

9. The transportation vehicle of claim 7, wherein the sound receiver is an ultrasonic parking sensor for detecting distance of the transportation vehicle from an obstacle.

10. A communication system for providing secure communications between a transportation vehicle and infrastructure, the communication system comprising:
a communication control system including a processor and a memory device, the processor executing instructions stored on the memory device to provide commands based on the executed instructions; and
a sound generator for providing one or more sound signals based on the commands from the communication system, wherein the one or more sound signals include a token having a signature enabling verification that the token remains unaltered.

11. The communication system of claim 10, wherein the token includes a payload for communication to one or more infrastructure devices.

12. The communication system of claim 11, wherein the payload includes payment information.

13. The communication system of claim 11, wherein the token is encrypted to conceal the payload from unauthorized access.

14. The communication system of claim 10, wherein the sound generator includes an ultrasonic sound generator and the sound signals include ultrasonic frequencies.

15. The communication system of claim 14, wherein the ultrasonic generator is an ultrasonic parking device for determining distance between the transportation vehicle and an obstacle.

16. The communication system of claim 10, wherein the sound generator includes a sound receiver for receiving sound signals.

17. The communication system of claim 16, wherein the sound receiver receives inbound sound signals from one or more infrastructure devices and communicates the inbound sound signals to the communication system.

18. The communication system of claim 17, wherein the sound receiver is an ultrasonic parking sensor for determining distance between the transportation vehicle and an obstacle.

19. A method of providing secure communication for a transportation vehicle including a vehicle chassis and a communication system, the method comprising:
a processor executing instructions stored on a memory device coupled thereto to provide communication commands based on the executed instructions; and
the communication system generating one or more sound signals based on the communication commands using a sound generator,
wherein the one or more sound signals include a token having a signature enabling verification that the token remains unaltered.

20. The method of claim 19, wherein the token includes a payload for communication to one or more infrastructure devices.

21. The method of claim 20, wherein the payload includes payment information.

22. The method of claim 20, wherein the token is encrypted to conceal the payload from unauthorized access.

23. The method of claim 19, wherein the sound signals include ultrasonic frequencies.

24. The method of claim 19, wherein the ultrasonic generator is an ultrasonic parking device for determining distance between the transportation vehicle and an obstacle.

25. The method of claim 19, wherein the communication system includes a sound receiver for receiving sound signals.

26. The method of claim 25, wherein the sound receiver receives inbound sound signals from one or more infrastructure devices and communicates the inbound sound signals to the communication system.

27. The method of claim 25, wherein the sound receiver is an ultrasonic parking sensor for detecting distance of the transportation vehicle from an obstacle.
